(19) United States
(12) Patent Application Publication
(10) Pub. No.: US 2018/0187498 A1
(43) Pub. Date: Jul. 5, 2018

(54) SYSTEMS AND METHODS FOR EARLY WELL KICK DETECTION

(71) Applicant: General Electric Company, Schenectady, NY (US)

(72) Inventors: Gerardo Alonso Sanchez Soto, Rio de Janeiro (BR); Rafael Horschutz Nemoto, Rio de Janeiro (BR)

(21) Appl. No.: 15/397,247

(22) Filed: Jan. 3, 2017

(51) Int. Cl. E21B 21/08; E21B 47/10; E21B 44/00; E21B 47/06; G08B 5/36; G08B 21/18; G06F 17/50; E02B 1/02

(52) U.S. Cl. CPC E21B 21/08; E21B 47/1005; E21B 44/00; E21B 47/06; E02B 1/02; G08B 5/36; G08B 21/182; G06F 17/5009; E21B 47/065

(57) ABSTRACT

An early kick detection system including a kick detection computing device coupled to at least one sensor associated with a drilling system of a well. The kick detection computing device is configured to receive measurement data from the at least one sensor. The measurement data includes one or more kick indicators used to identify a well kick. The kick detection computing device generate an estimated value for each of the one or more kick indicators during simulated normal drilling conditions and simulated kick conditions. The kick detection computing device determines a deviation value and generates a signal based on the deviation value. The signal activates a green status, an amber warning, or a red alarm to indicate a kick detection status of the drilling system.

### BACKGROUND

The field of the disclosure relates generally to oil and gas drilling operations and, more particularly to a system and method for detecting a well kick during drilling operations using a drilling hydraulic model.

An undesirable event in a drilling operation is taking an influx of formation fluids into a wellbore, known as a well kick. It is known that there is a preexistent pressure on the formations of the earth, which, in general, increases as a function of depth due to the weight of the overburden on particular strata. This weight increases with depth so the prevailing or quiescent bottom hole pressure is increased in a generally linear curve with respect to depth. As the well depth is doubled in a normal-pressured formation, the pressure is likewise doubled. This is further complicated when drilling in deep water or ultra-deep water because of the pressure on the sea floor by the water above it. Thus, high pressure conditions exist at the beginning of the hole and increase as the well is drilled. On some known occasions, the pressure in the hole forces material back into the wellbore and cause a well kick. In basic terms, a well kick occurs when the gases or fluids in the wellbore flow out of the formation into the wellbore and bubble upward. An uncontrolled well kick may eventually result in a blowout, leading to costly environmental and financial consequences.

Known well kick detection systems involve the monitoring of various inputs, including the combination of crew-member reporting of visual observations and sensor data displayed on an operator's console. For example, a well kick may be detected by comparing conventional rig data measurements from sensors located topsides to predefined thresholds. Through extensive well-control training, an operator learns to detect a well kick using an experience-based tacit procedure by analyzing different sources of information and trends. However, the definition of thresholds is usually based on the operator's experience, thus not being a reliable method for well kick detection.

### BRIEF DESCRIPTION

In one aspect, an early kick detection system is provided. The early kick detection system includes at least one sensor associated with a drilling system of a well. The early kick detection system also includes a kick detection computing device. The kick detection computing device is coupled to the at least one sensor and an operator computing device. The kick detection computing device is configured to receive measurement data from the at least one sensor. The measurement data includes data measurements associated with one or more kick indicators used to identify a well kick. The kick detection computing device is also configured to generate an estimated value for each of the one or more kick indicators during simulated normal drilling conditions. The kick detection computing device is further configured to generate an estimated value for each of the one or more kick indicators during a simulated kick condition. The kick detection computing device is also configured to determine a deviation value between the estimated values of the one or more kick indicators and the data measurements associated with the one or more kick indicators. The kick detection computing device is further configured to generate a signal based on the deviation value. The signal activates a green status, an amber warning, or a red alarm. The green status, the amber warning, and the red alarm indicate a kick detection status of the drilling system. The kick detection computing device is also configured to transmit the signal to the operator computing device. The operator computing device is configured to display the kick detection status of the drilling system.

In another aspect, a method for controlling an early kick detection system is provided. The early kick detection system includes at least one sensor associated with a drilling system of a well and a kick detection computing device coupled to the at least one sensor and an operator computing device. The method includes receiving, by the kick detection computing device, measurement data from the at least one sensor. The measurement data includes data measurements associated with one or more kick indicators used to identify a well kick. The method further includes generating, by the kick detection computing device, an estimated value for each of the one or more kick indicators during simulated normal drilling conditions. The method also includes generating, by the kick detection computing device, an estimated value for each of the one or more kick indicators during a simulated kick condition. The method further includes determining, by the kick detection computing device, a deviation value between the estimated values of the one or more kick indicators and the data measurements associated with the one or more kick indicators. The method also includes generating, by the kick detection computing device, a signal based on the deviation value. The signal activates a green status, an amber warning, or a red alarm. The green status, the amber warning, and the red alarm indicate a kick detection status of the drilling system. The method further includes transmitting, by the kick detection computing device, the signal to the operator computing device. The operator computing device is configured to display the kick detection status of the drilling system.

In yet another aspect, a non-transitory computer-readable storage medium having computer-executable instructions embodied thereon is provided. When executed by a kick detection computing device coupled to at least one sensor associated with a drilling system of a well and an operator computing device, the computer-executable instructions cause the kick detection computing device to receive measurement data from the at least one sensor. The measurement data includes data measurements associated with one or more kick indicators used to identify a well kick. The computer-executable instructions also cause the kick detection computing device to generate an estimated value for each of the one or more kick indicators during simulated normal drilling conditions. The computer-executable instructions further cause the kick detection computing device to generate an estimated value for each of the one or more kick indicators during a simulated kick condition. The computer-executable instructions also cause the kick detection computing device to determine a deviation value between the estimated values of the one or more kick indicators and the data measurements associated with the one or more kick indicators. The computer-executable instructions further cause the kick detection computing device to generate a signal based on the deviation value, wherein the signal activates a green status, an amber warning, or a red alarm. The green status, the amber warning, and the red alarm indicate a kick detection status of the drilling system. The computer-executable instructions also cause the kick detection computing device to transmit the signal to the operator computing device. The operator computing device is configured to display the kick detection status of the drilling system.

### DRAWINGS

These and other features, aspects, and advantages of the present disclosure will become better understood when the following detailed description is read with reference to the accompanying drawings in which like characters represent like parts throughout the drawings, wherein:

FIG. 1 is an exemplary configuration of a drilling system including a subsea well being drilled or completed and a kick detection computing device;

FIG. 2 is a block diagram of an exemplary computing device such as the kick detection computing device shown in FIG. 1;

FIG. 3 is a schematic view of an exemplary flowchart for automatically detecting a well kick; and

FIG. 4 is a schematic view of an exemplary method for detecting a well kick using an early kick detection computing device.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the terms “intelligence” and “intelligent” are intended to be descriptive of any computer-implemented programs and computer-based systems that are implemented such that they demonstrably exhibit abilities, including, without limitation, attention, abstract thought, understanding, communication, reasoning, learning, planning, emotional intelligence and/or problem solving.

As used herein, the terms “cognitive” and “cognition” are intended to be descriptive of any computer-implemented programs and computer-based systems that execute processes that include, without limitation, continuous learning, adaptation, planning, remembering, forgetting, language, memory structure, perception, communicating, deliberating, applying knowledge, solving problems, making decisions, changing preferences, sensory input, internal thinking, and reflex actions. Cognition, or cognitive processes, can be artificial including states of intelligent entities, such as, highly autonomous machines and artificial intelligences that have the ability to process, e.g., take into consideration, feedback from the environment.

As used herein, the terms “intelligent system”, “artificial intelligence”, “intelligent agent”, and “artificial consciousness” are intended to be representative of, without limitation, any computer-implemented programs and computer-based systems that perceive their environments, independently determine courses of action, and take the actions that will maximize the chances of success.

As used herein, the term “SVM clustering” is intended to be representative of any computer-implemented and computer-based methods that use an SVM-based clustering algorithm to classify and categorize data according to the attributes of the data. Such attributes may be predefined, including each attribute having a predefined relevance, and the clustering algorithm will cluster according to the predefined attributes and their degree of relevance. Such SVM clustering algorithms are typically referred to as “supervised” SVM algorithms and require external support for their training. Alternatively, such attributes may be undefined and the clustering algorithm will self-determine such attributes, sort accordingly, and review the sorted data for attribute consistency, thereby performing self-training. Such SVM clustering algorithms are typically referred to as “non-parametric” SVM algorithms and require little to no external support for their training.

As used herein, the term “genetic algorithm (GA)” is intended to be representative of any portion of computer-implemented programs and computer-based systems that includes a search heuristic that emulates the process of natural evolution to generate useful resolutions to optimization and search problems.

As used herein, the term “heuristic” is intended to be representative of any portion of computer-implemented programs and computer-based systems that uses experience-based techniques for problem solving, learning, and discovery.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program stored in memory for execution by personal computers, workstations, clients and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

The early kick detection system described herein provides for automatic real time detection of well kicks during a subsea drilling operation. Specifically, the embodiments described herein include a kick detection computing device configured to analyze data streams from different sources to identify an early stage formation of a well kick. The kick detection computing device includes a memory and a processor in communication with the memory and a plurality of sensors associated with the subsea drilling operation. The kick detection computing device receives data measurements from a tool joint locator, an annular flow meter, and sensors available at a drilling rig. The kick detection computing device processes the data using a physics-based mathematical model called a drilling hydraulic model, a drilling operation identification module, a joint position estimation module, and a data analytics module to determine an occurrence of an early stage well kick. Once a well kick is detected, warnings and alarms are presented to drilling system operators. Therefore, the embodiments described herein enable the drilling system operators to safely control the well kick by, for example, circulating formation fluid coming into the drilling system. Thus, the early kick detection computing device improves well control, reduces unnecessary well shut-in events, and reduces costs related to drilling operations.

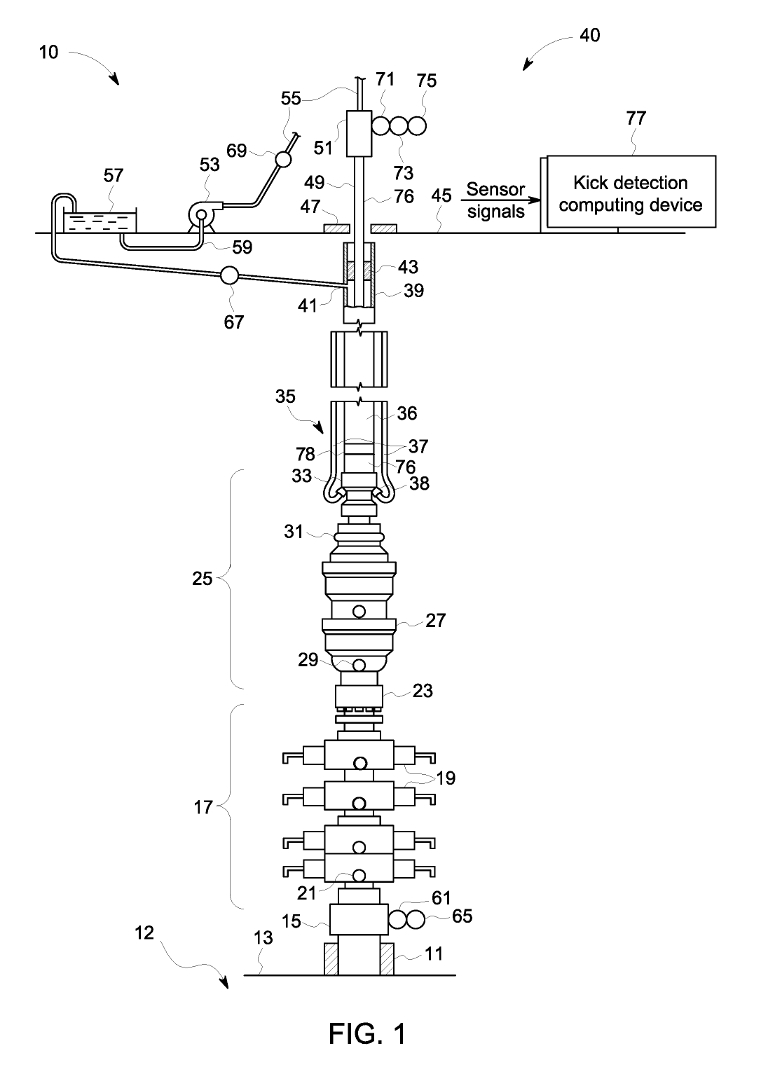

FIG. 1 is an exemplary configuration of a drilling system 10 including subsea well 12 being drilled or completed. Well 12 has been at least partially drilled, and has a subsea wellhead assembly 11 installed at sea floor 13. At least one string of casing (not shown) is suspended in well 12 and supported by wellhead assembly 11. Well 12 may have an open hole portion not yet cased, or it could be completely cased, but the completion of well 12 not yet finished.

A hydraulically actuated connector 15 releasably secures a blowout preventer (BOP) stack 17 to the wellhead assembly 11. BOP stack 17 has several ram preventers 19, some of which are pipe rams and at least one of which is a blind ram. The pipe rams have cavities sized to close around and seal against pipe extending downward through wellhead assembly 11. The blind rams are capable of shearing the pipe and affecting a full closure. Each of the rams 19 has a port 21 located below the closure element for pumping fluid into or out of well 12 while the ram 19 is closed. The fluid flow is via choke and kill lines (not shown).

A hydraulically actuated connector 23 couples a lower riser marine package (LMRP) 25 to the upper end of BOP stack 17. Some of the elements of LMRP 25 include one or more annular BOP's 27 (two shown). Each annular BOP 27 has an elastomeric element that closes around pipes of any size. Also, annular BOP 27 can make full closure without a pipe extending through it. Each annular BOP 27 has a port 29 located below the elastomeric element for pumping fluid into or out of well 12 below the elastomeric element while annular BOP 27 is closed. The fluid flow through port 29 is handled by choke and kill lines. Annular BOP's 27 alternately could be a part of BOP stack 17, rather than being coupled to BOP stack 17 with a hydraulically actuated connector 23.

LMRP 25 includes a flex joint 31 capable of pivotal movement relative to the common axis of LMRP 25 and BOP stack 17. A hydraulically actuated riser connector 33 is mounted above flex joint 31 for connecting to the lower end of a string of riser 35. Riser 35 is made up of joints of pipe 36 secured together. Auxiliary conduits 37 are spaced circumferentially around central pipe 36 of riser 35. Auxiliary conduits 37 are of smaller diameter than central pipe 36 of riser 35 and serve to communicate fluids. Some of the auxiliary conduits 37 serve as choke and kill lines. Others provide hydraulic fluid pressure. Flow ports 38 at the upper end of LMRP 25 couple certain auxiliary conduits 37 to the various actuators. When connector 33 decouples from central riser pipe 36 and riser 35 is lifted, flow ports 38 also decouples from the auxiliary conduits 37. At the upper end of riser 35, auxiliary conduits 37 are coupled to hoses (not shown) that extend to various equipment on a floating drilling vessel or platform 40.

Electrical and optionally fiber optic lines extend downward within an umbilical to LMRP 25. The electrical, hydraulic, and fiber optic control lines lead to one or more control modules (not shown) mounted to LMRP 25. The control module controls the various actuators of BOP stack 17 and LMRP 25.

Riser 35 is supported in tension from platform 40 by hydraulic tensioners (not shown). The tensioners allow platform 40 to move a limited distance relative to riser 35 in response to waves, wind and current. Platform 40 has equipment at its upper end for delivering upwardly flowing fluid from central riser pipe 36. This equipment may include a flow diverter 39, which has an outlet 41 leading away from central riser pipe 36 to platform 40. Diverter 39 may be mounted to platform 40 for movement with platform 40. A telescoping joint (not shown) may be located between diverter 39 and riser 35 to accommodate this movement. Diverter 39 has a hydraulically actuated seal 43 that when closed, forces all of the upward flowing fluid in central riser pipe 36 out outlet 41.

Platform 40 has a rig floor 45 with a rotary table 47 through which a pipe is lowered into riser 35 and into well 12. In this example, the pipe is illustrated as a string of drill pipe 49, but it could alternately include other well pipe, such as liner pipe or casing. Drill pipe 49 is shown coupled to a top drive 51, which supports the weight of drill pipe 49 as well as supplies torque. Top drive 51 is lifted by a set of blocks (not shown), and moves up and down a derrick while in engagement with a torque transfer rail. Alternately, drill pipe 49 could be supported by the blocks and rotated by rotary table 47 via slips (not shown) that wedge drill pipe 49 into rotating engagement with rotary table 47.

Mud pumps 53 (only one illustrated) mounted on platform 40 pump fluids down drill pipe 49. During drilling, the fluid is normally drilling mud. Mud pumps 53 are coupled to a line leading to a mud hose 55 that extends up the derrick and into the upper end of top drive 51. Mud pumps 53 draw the mud from mud tanks 57 (only one illustrated) via intake lines 59. Riser outlet 41 is coupled via a hose (not shown) to mud tanks 57. Cuttings from the earth boring occurring are separated from the drilling mud by shale shakers (not shown) before reaching mud pump intake lines 59.

A well kick (hereafter referred to as a “kick”), defined as an unscheduled entry of formation fluids into the wellbore, may occur while drilling or while completing a well. Basically, the kick occurs when an earth formation has a higher pressure than the hydrostatic pressure of the fluid in well 12. If well 12 has an uncased or open hole portion, the hydrostatic pressure acting on the earth formation is that of the drilling mud. Operating personnel control the weight of the drilling mud so that it provides enough hydrostatic pressure to avoid a kick. However, if the mud weight is excessive, it may flow into the earth formation, damaging the formation and causing lost circulation. Consequently, operating personnel balance the weight so as to provide sufficient weight to prevent a kick but avoid fluid loss.

A kick may occur while drilling, while tripping the drill pipe 49 out of well 12, or running the drill pipe 49 into well 12. A kick may also occur while lowering logging instruments on wire line into well 12 to measure the earth formation. A kick may occur even after well 12 has been cased, such as by a leak through or around the casing or between a liner top and casing. In that instance, the fluid in well 12 may be water, instead of drilling mud. If not mitigated, a kick may result in high pressure hydrocarbon flowing to the surface, possibly pushing the drilling mud and any pipe in the well upward. The hydrocarbon may be gas, which can inadvertently be ignited.

Drilling system 10 includes a plurality of sensors, of which only a few are illustrated. The sensors are intended to provide an early detection of a kick, and more or fewer may be used. Some of the sensors may be helpful only during drilling, but not while tripping the drill pipe or performing other operations, such as cementing.

A return flow rate sensor 67 senses the flow rate of the drilling mud returning, or the flow rate of any upward flowing fluid. Return flow rate sensor 67 is located in outlet 41 as shown or in connector 15. An inflow sensor 69 is located at the outlet of mud pumps 53 to determine the flow rate of fluid being pumped into well 12. A wellhead bore pressure sensor 61 is located just above wellhead assembly 11 within BOP stack 17 below the lowest ram 19. The signals from wellhead bore pressure sensor 61 are transmitted conventionally, such as through wires and fiber optic sensors that may be part of the umbilical leading to platform 40. Wellhead bore pressure sensor 61 indicates the pressure at all times that exist within wellhead assembly 11. While circulating drilling mud down through drill pipe 49, the pressure sensed is the pressure of the returning drilling mud outside of drill pipe 49 at that point. That pressure depends on the hydrostatic pressure of the drilling mud above sensor 61, which is proportional to the sea depth.

In addition, one or more temperature sensors 65 are employed to sense a temperature of the upward flowing fluid. Temperature sensor 65 is also preferably in connector 15 for sensing the temperature of fluid in the bore of wellhead assembly 11. A string weight sensor 71 is mounted to top drive 51, or to the blocks, for sensing the weight of the pipe string being supported by the derrick. During drilling, the weight of drill pipe 49 sensed depends on how much weight of the drill pipe 49 is applied to the drill bit. A rate of penetration (ROP) sensor 73 measures how fast drill pipe 49 is moving downward. A torque sensor 75 is mounted at or near top drive and senses the amount of torque being imposed during drilling. An annular flow meter (AFM) 76 is designed as a flow spool located in the marine riser and close to the subsea BOP stack. The annular flow meter indicates the mud flow rate at all times that exist within marine riser 35 annulus. While circulating drilling mud down through drill pipe 49, the mud flow rate sensed is the flow rate of the returning drilling mud outside of drill pipe 49 at that point. A tool joint locator (TJL) 78 is located above AFM 76. Tool joint locator 78 determines the relative location of pipe joints inside BOP stack 17.

A kick detection computing device 77 on platform 40 receives signals from sensors 61, 65, 67, 69, 71, 73, 75, 76 and 78, and possibly others. As described herein, kick detection computing device 77 processes these signals to detect whether a kick is occurring and issues alerts and/or control signals in response.

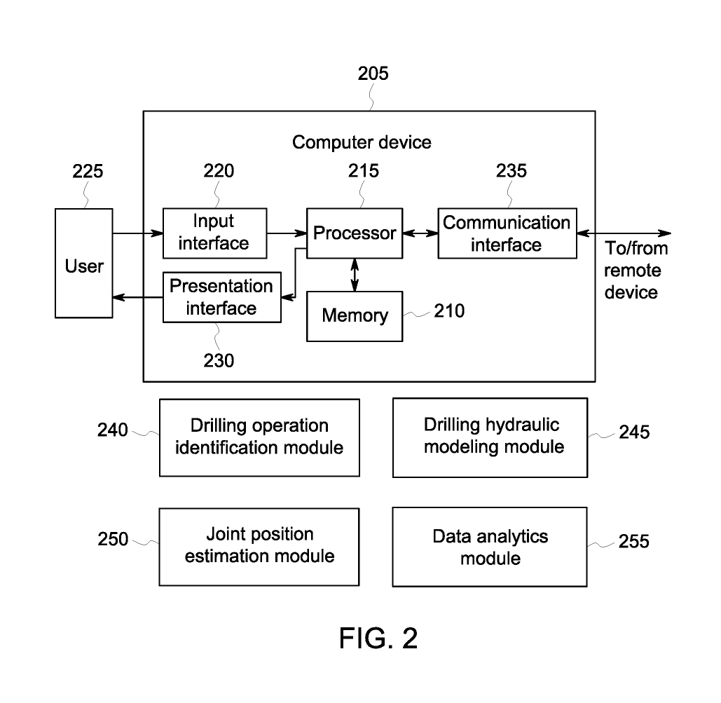

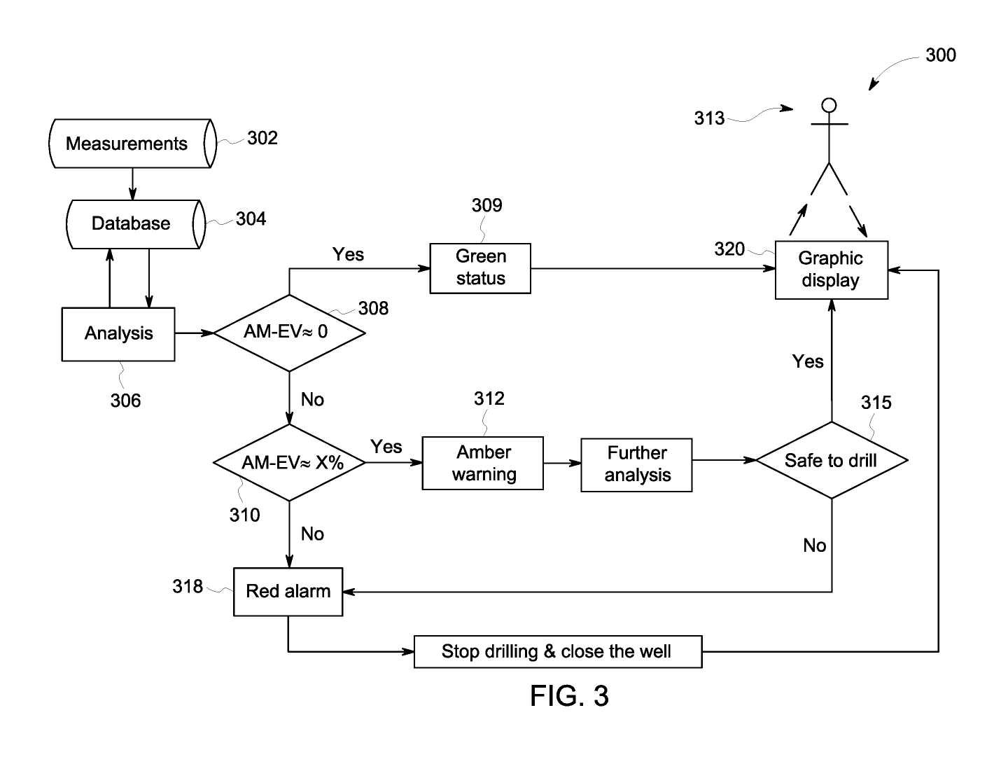

FIG. 2 is a block diagram of an exemplary computer device 205, such as kick detection computing device 77 (shown in FIG. 1). Computer device 205 is configured to use an advanced mathematical model, known as a drilling hydraulic model, for determining expected behavior of relevant variables during simulated normal drilling operations and during simulated abnormal drilling operation involving a kick occurrence. In the exemplary embodiment, pressure, temperature, and flow rate measured at different positions in the drilling system may be used as relevant parameters. As further described below and in FIG. 3, kick detection computer device 205 detects a kick by comparing data measurements received from sensors with the variables for the normal operation and the abnormal operation.

Computer device 205 includes a memory device 210 and a processor 215 operatively coupled to memory device 210 for executing instructions. In some embodiments, executable instructions are stored in memory device 210. Computer device 205 is configurable to perform one or more operations described herein by programming processor 215. For example, processor 215 may be programmed by encoding an operation as one or more executable instructions and providing the executable instructions in memory device 210. In the exemplary embodiment, memory device 210 is one or more devices that enable storage and retrieval of information such as executable instructions and/or other data. Memory device 210 may include one or more computer readable media. Memory device 210 is configured to store sensor data and/or any other type data. Also, memory device 210 includes, without limitation, sufficient data, algorithms, and commands to facilitate generating a data-driven early detection of a kick.

Computer device 205 receives data associated with drilling system 10. For example, computer device 205 receives data from, but not limited to, a tool joint locator (TJL), a subsea annular flow meter (AFM), a drilling rig monitoring system, input data from a user, and measurements from other sensors typically available at a drilling rig. The AFM is configured as a flow spool located in riser 35 (shown in FIG. 1) and close to BOP stack 17 (shown in FIG. 1) to monitor a flow rate of drilling fluid coming out of the drill string into the annulus of riser 35. The AFM provides local flow rate measurements (returning mud flow rate in the annulus). The TJL is also located above BOP stack 17 and scans drill pipe 49 for identifying when tool joints pass across a TJL sensor. The TJL sensor provides a signal that shows oscillation once a joint is detected. The information of the TJL enables computer device 205 to better define a true length of different sections of well 12 (shown in FIG. 1) such that more accurate hydraulic calculations are made.

Besides these sensors, computer device 205 also receives variable measurements from conventional sensors located at the drilling rig (i.e., drilling rig monitoring system). The measured variables includes, but are not limited to, drill pipe rate of penetration (ROP), pressures at standpipe and return line, mud pit level, inlet and outlet flow rate, pump state, and drill pipe rotation. In addition, a user may provide data, such as well plan data, drill pipe/casing geometry, and fluid properties. Not all of the abovementioned data sources are necessary for the early kick detection system to operate, although additional data increases the accuracy of the system.

In the exemplary embodiment, computer device 205 includes a presentation interface 230 and a user input interface 220. Presentation interface 230 is coupled to processor 215 and presents information to user 225. User input interface 220 is coupled to processor 215 and receives input from user 225.

Communication interface 235 is coupled to processor 215 and is configured to be coupled in communication with one or more other devices, such as one or more sensors, and to perform input and output operations with respect to such devices while performing as an input channel. For example, communication interface 235 of computer device 205 transmits a signal to communication interface 235 of another computing device (not shown). Computer device 205 also uses communication interface 235 to transmit outputs indicators, diagnostics, and alarms to user 225.

In the exemplary embodiment, computer device 205 includes or is in communication with four modules, a drilling operation identification module 240, a drilling hydraulic modeling module 245, a joint position estimation module 250, and a data analytics module 255, as described below.

Drilling operation identification module 240 manages the flow of data between monitoring systems, data analytics module 255, and the different output system used to convey the results from performed analysis. Drilling operation identification module 240 also involves different communication protocols, different data acquisition rates, and a varied number of inputs and outputs. More specifically, drilling operation identification module 240 is configured to receive rig operational data, such as a drilling phase, a drilling method, and a drilling operation. The drilling phases may be exploratory or development. The drilling methods may be conventional drilling, underbalance drilling, managed pressure drilling (MPD), or dual gradient drilling (DGD). The current drilling operation includes drilling ahead, making a connection, tripping out, or out of the hole. The drilling phase and drilling method are predefined. Different data sources and analyses may be selected depending on the drilling phase, drilling method and drilling operation being performed.

Drilling hydraulic modeling module 245 is configured to generate a drilling hydraulic model to perform simulations using received data measurements. Drilling hydraulic modeling module 245 performs simulations of normal drilling operation conditions to obtain one or more reference values. A reference value, also known as a kick indicator, is an estimated variable, such as pressure, that is relevant to whether a kick condition exists. Drilling hydraulic modeling module 245 further performs simulations of drilling operation conditions during kick conditions to obtain one or more reference values. Drilling hydraulic modeling module 245 performs comparative analysis with the reference values and the received data measurements. The reference values for normal conditions and kick conditions are compared against the received data measurements to determine a deviation. Drilling hydraulic modeling module 245 identifies a kick based on whether the deviation exceeds a predefined threshold. In the exemplary embodiment, pressure, temperature, and flow rate measured at different positions in the drilling system may be used as reference values.

In the exemplary embodiment, the simulation of normal drilling operation refers to a drilling operation in which there is no influx from reservoir. Thus, drilling hydraulic modeling module 245 is able to calculate flow rates, pressure profile, and temperature profile along drill pipe 49 (shown in FIG. 1) and annulus, which are the reference values for a normal operation. The simulation of abnormal drilling operation refers to a drilling operation in which an influx from reservoir is considered to occur. Different flow rates, compositions and locations for the influx may be considered. Thus, the hydraulic model is able to calculate flow rates, pressure profile and temperature profile along drill pipe 49 and annulus, which are the reference values for an abnormal operation.

The hydraulic simulation refers to the solution of conservation equations (mass, momentum and energy conservation equations) for a pseudo steady-state condition, in which drill bit is considered to deepen the hole. In the exemplary embodiment, the hydraulic simulation includes, but is not limited to the following assumptions: Pseudo steady-state simulations, e.g., drill bit is considered to deepen the hole; One-dimensional flow, Discretization based on section lengths (aka control volumes); For normal operation (i.e. no kick occurrence), it is considered single-phase flow of mud at drill pipe 49 and multiphase flow of mud and particles at the annulus; For abnormal operation (i.e. kick occurs during drilling), it is considered single-phase flow of mud at drill pipe 49 and multiphase flow of mud, particles, gas, and oil at the annulus; Liquid and solid phases are homogenized, i.e. no slip among phases for mud, oil, and particles; Slip is considered between gas and liquid and solid phases; Drift flux model is considered as closure law; Pressure drop, with gravitational and frictional components, is calculated by means of the No-Pressure-Wave (NPW) model; Heat transfer calculations consider mixture temperature at each control volume, heat conduction on pipe through walls, and heat convection on inner and outer near-wall regions; mud rheology module includes Bingham plastic, Power law, among others; Black-oil approximation may be used for estimating gas and oil fluid properties and mass transfer; Drill bit pressure drop is calculated by considering an orifice pressure drop equation.

In the exemplary embodiment, the drilling hydraulic model will take the mud flowrate injected into the well along with the mud properties so that the hydraulic calculation of the given system geometry (i.e., rig pipeline system, marine riser and wellbore being drilled) is done. To update the wellbore geometry, drilling hydraulic modeling module 245 will update the depth of the wellbore using the ROP and time for a given wellbore section being drilled along with data from the Tool Joint Location sensor data. Drilling hydraulic modeling module 245 may use the rest of the data received for initial fine tuning of the hydraulic model to get the reference line.

Drilling hydraulic modeling module 245 runs continuous hydraulic simulations under normal operational conditions; as a result, the flowrates, pressure, and temperature profile along the system will be recorded. The normal operation variable profiles are then compared with the actual measurements from the monitoring system in place (subsea and surface) so that any deviation is detected and quantified. Hydraulic simulations under different kick conditions (i.e., previously selected inflow values) are performed so that those variable profiles are available for comparison with the actual measurements. This comparison will give the severity of the kick that will help the decision-making process on control actions to be taken.

Joint position estimation module 250 receives data signals from the TJL and estimates a tool joint position with relation to the several BOP rams (shear ram, blind ram, and annular ram). A distance of the tool joint position relative to the rams is presented to user 225. Joint position estimation module 250 further estimates a true measured depth (TVD) of well 12, which may be used in the drilling hydraulic model.

Data analytics module 255 uses supervised and unsupervised machine learning techniques for finding trends and identifying characteristic deviations caused by kicks. Data analytics module 255 receives measurement data as described herein and generates time series plots such that trends may be identified or potential deviations may be detected. Data analytics module 255 may apply a variety of methods to detect trends, patterns, and anomalies in the time series plots. For example, in one embodiment, data analytics module 255 uses multivariate anomaly detection techniques to take into account the covariance between multiple signals being monitored, when searching for anomalies. In another embodiment, data analytics module 255 uses unsupervised learning techniques to classify and test historical data.

Data analytics module 255 further analyzes detected deviations by cross-checking with other relevant variables to establish a magnitude and criticality of an event. Methods such as trends evaluation and comparison between data measurements and reference values are used.

Data analytics module 255 is designed to operate with an artificial intelligence software program and/or machine learning software program. Known techniques from data analysis are expected to be applicable here, including machine learning, cognitive systems, pattern recognition, cluster recognition (SVM clustering), genetic algorithms, heuristics, and big data analysis. In some embodiments, an artificial intelligence algorithm is implemented that learns from the sensor data and/or the operator input. For example, data analytics module 255 is configured to learn, based on sensor data or operator input, characteristic deviations caused by influxes.

In some embodiments, data analytics module 255 identifies and responds to faulty sensors to prevent biased data leading to an unresponsive detection system. Data analytics module 255 outputs indicators, diagnostics, and alarms to user 225 using, for example, presentation interface 230, enabling user 225 to quickly respond to a possible kick occurrence.

Also in some embodiments, computer device 205 facilitates operation of one or more components of drilling system 10. Computer device 205 includes sufficient computer-readable/executable instructions, data structures, program modules, and program sub-modules, to facilitate control of the one or more components of drilling system 10. Computer device 205 includes input interface 220 and presentation interface 230 for inputting automated or manual operation commands to drilling system 10 while simultaneously receiving back information that enables user 225 to monitor an operating state of drilling system 10 according to the operation commands. In such an embodiment, computer device 205 controls at least some of the operation of drilling system 10 in accordance with the operation commands, for example, using processor 215 for implementing a control strategy. In additional embodiments, computer device 205 instructs the operator to suspend operations, automatically suspends a predefined operating sequence, initiates drilling to stop, or triggers an automatic well shutdown, based on a determined deviation.

FIG. 3 is a schematic view 300 of an exemplary flowchart to automatically detect a kick. Data measurements 302 from sensors associated with drilling system 10 (shown in FIG. 1) are transmitted to a kick detection computing device, such as kick detection computing device 77, and stored in a database 304. Data measurements 302 include, but are not limited to, drilling rig measurements, subsea annular flow meter (AFM) measurements, and TJL measurements. Rig measurements include, but are not limited to, pump pressure, casing pressure, standpipe pressure, return line pressure, flow-in temperature, joint count, mud flow rate injected in the drill string (calculated based on pump stroke rate, stroke volume, and pump efficiency), mud level in a pit volume totalizer (PVT) or mud pit, trip tank volume indicator, ROP (drill bit's rate of penetration), inlet and outlet flow rate, drill string pressure and temperature at surface level, annular pressure and temperature at surface level, mud properties, pump state, drill pipe rotation, pump speed (rpm), pressure differential, and cuttings features (size, shape and volume). Drilling rig measurements are used as boundary conditions for calculations. Subsea AFM measurements include annular flow rate. The TJL measurement determines a location of the pipe joint in the BOP, a number of joints into well 12 (shown in FIG. 1), and provides data for estimating total measured depth (TMD). The TJL may be utilized to ensure that only the drill pipe (no joints) is located in the shear ram section in an event of activation. A user also provides the kick detection computing device with well plan data and rig operational data, including a well profile and casing/open hole configuration.

Drilling hydraulic modeling module 245 (shown in FIG. 2) analyzes 306 data measurements 302 using data analytics techniques to determine an occurrence of a kick. More specifically, drilling hydraulic modeling module 245 (shown in FIG. 2) is configured to generate a drilling hydraulic model to perform hydraulic simulations using received data measurements 302. The drilling hydraulic model uses data measurements 302 to perform hydraulic simulations of normal drilling operation conditions to obtain one or more reference values. The drilling hydraulic model further uses data measurements 302 to perform hydraulic simulations of drilling operation conditions during kick conditions to obtain one or more reference values. In the exemplary embodiment, pressure, temperature, and flow rate measured at different positions in the drilling system may be used as reference values. The drilling hydraulic model performs comparative analysis with the reference values and data measurements 302. The drilling hydraulic model determines a deviation between the reference values and data measurement 302. The drilling hydraulic model identifies a kick based on whether the deviation exceeds a predefined threshold. The drilling hydraulic model uses case-based thresholds and expected deviations for a given drilling operation to determine whether a kick occurred.

For example, the data analytics module receives an actual value of a flow rate measured by the annular flow meter (Q_{AFM}). The data analytics module also receives a reference value of the flow rate for a normal drilling operation (Q_{AFM}_{_}_{EST}_{_}_{NORMAL}), estimated by using the drilling hydraulic model. The data analytics module also receives a reference value of the flow rate for an abnormal drilling operation (Q_{AFM}_{_}_{EST}_{_}_{ABNORMAL}), related to the occurrence of a kick, estimated by using the drilling hydraulic model. The data analytics module then determines the deviation between the actual value and the expected value for normal drilling operation (ΔQ_{NORMAL}) and abnormal drilling operation (ΔQ_{ABNORMAL}). The data analytics module compares the determined deviations (ΔQ_{NORMAL} and ΔQ_{ABNORMAL}) to predefined expected deviations for a given drilling operation to determine whether a kick occurred. For example, the data analytics module may verify the time evolution of the deviations by utilizing data analytics techniques for evaluating if the ΔQ_{NORMAL} increases and ΔQ_{ABNORMAL} decreases. This combination would indicate a kick occurrence. The drilling hydraulic model may also estimate other variables, such as pressure profiles, temperature profiles, and flow rate profiles along the drilling system. Such estimated variables at different positions could be compared to sensor measurements for verifying the occurrence of a kick. In some embodiments, the data analytics module performs real time flowrate comparison (ΔQ=Qₒᵤₜ−Qᵢₙ) to determine flow inconsistencies that may indicate fluid influx and a potential kick.

If there is no deviation 308 between the actual data measurements and the reference values for normal drilling operation, no kick is detected. In some embodiments, data analytics module 245 activates a green status 309 to indicate that drilling is safe. If the difference 310 between the actual data measurements and the reference values for normal drilling operation is equal to or greater than a predefined deviation, data analytics module 245 activates an amber warning 312 to indicate that further analysis is needed. An operator 313 then determines 315 whether it is safe to drill or whether a red alarm 318 should be raised. If the difference 310 between the actual data measurements and the reference values for normal drilling operation exceed the predefined deviation, data analytics module 245 activates red alarm 318 to indicate that a kick condition has been detected. Once a kick condition is detected, appropriate action should be taken, such as stopping drilling and closing well 12.

The kick detection threshold is configurable according to the well design. In one embodiment, a graphical user interface (GUI) 320 in communication with the kick detection computing device enables operator 313 to use a dedicated window to set an acceptable deviation value of variables to be used as a trigger of amber warning 312 and/or red alarm 318. This assists in avoiding unnecessary false alarms. The deviation value may be changed during drilling operations based on new operating conditions or formation data.

Data analytics module 245 transmits green status 309, amber warning 312, or red alarm 318 to an operator computing device, such as computer device 205, that includes GUI 320. Operator computing device is associated with drilling system operator 313. If red alarm 318 is triggered, warnings and alarms are presented to a drilling system operator 313 via GUI 320 or a separate alarm system. GUI 320 also emphasizes plots and analysis results that evidence a kick (influx) occurrence. The warnings and alarms ensure that operator 313 is aware of a potential operational risk. This enables operator 313 to concentrate on a task at hand and avoid looking at a vast stream of data coming from different sensors of a monitoring system that may overwhelm operator 313. Therefore, the embodiments described herein enable operator 313 to safely control the influx coming into the drilling system.

In one embodiment, drilling operation identification module 240, drilling hydraulic modeling module 245, joint position estimation module 250, and/or data analytics module 255 presents information about drilling system 10 to operator 313 using GUI 320. GUI 320 is a software tool that links and integrates the data available during drilling operations. For example, data analytics module 255 presents operational information to operator 313 through GUI 320. Data analytics module 255 generates plotting of key drilling variables, trend plots and trend analysis, BOP joint position, length of drill string in well 12, pressure profile, equivalent circulating density (ECD), and updated well geometry. GUI 320 also visualizes the position of drill pipe joints with relation to BOP stack 17 (shown in FIG. 1) through dynamic illustrations. As used herein, the term “operator” includes any person in any capacity associated with operating and maintaining drilling system 10, including, without limitation, shift operations personnel, maintenance technicians, and facility supervisors.

The integrated use of the displayed data on GUI 320 generates an improved picture of operational conditions and assists in detecting potential deviations indicating a kick event. GUI 320 enables operator 313 to view and respond appropriately to kick conditions to ensure safe and reliable operation of drilling system 10. GUI 320 enables an at-a-glance comparison of the reference values for simulated normal conditions, simulated abnormal conditions, and actual measurement data. Operator 313 may then take a variety of remedial action to control a kick.

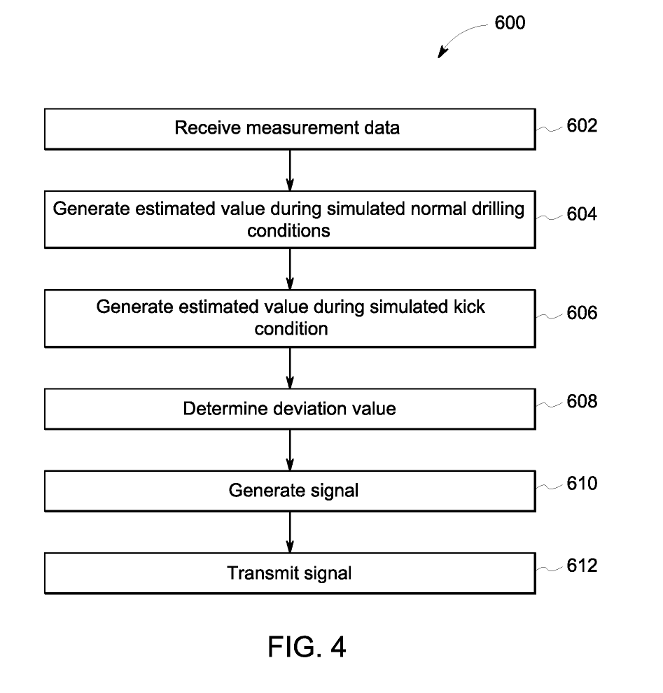

FIG. 4 is a schematic view of an exemplary method 600 for detecting a kick using early kick detection computing device 77 (shown in FIG. 1) described herein. Early kick detection computing device 77 includes a plurality of sensors associated with drilling system 10 (shown in FIG. 1). Early kick detection computing device 77 further includes kick detection computing device 77 (shown in FIG. 1) coupled to the plurality of sensors and an operator computing device that includes GUI 320 (shown in FIG. 3). Kick detection computing device 77 is configured to receive 602 measurement data from the plurality of sensors, wherein the measurement data includes data measurements associated with one or more kick indicators (also referred to as “reference values”) used to identify a well kick. Kick detection computing device 77 generates 604 an estimated value for each of the one or more kick indicators during simulated normal drilling conditions. Kick detection computing device 77 also generates 606 an estimated value for each of the one or more kick indicators during a simulated kick condition. Kick detection computing device 77 then determines 608 a deviation value between the estimated values of the one or more kick indicators and the data measurements associated with the one or more kick indicators.

Based on the deviation value, kick detection computing device 77 generates 610 a signal that activates green status 309, amber warning 312, or red alarm 318 (all shown in FIG. 3). Green status 309, amber warning 312, and red alarm 318 indicate a kick detection status of drilling system 10. Kick detection computing device 77 transmits 612 the signal to the operator computing device, wherein the operator computing device is configured to display the kick detection status of drilling system 10 on GUI 320.

The above described early kick detection system provides a system and method for automatic early detection of a kick event during deep water drilling. Specifically, the embodiments described herein include a kick detection computing device configured to analyzes data streams from different sources in real-time to identify an occurrence of a kick in an early stage for fast response. The kick detection computing device includes a memory and a processor in communication with the memory and a plurality of sensors. The fault management computing device receives data measurements from the plurality of sensors, particularly a tool joint locator and an annular flow meter. The kick detection computing device processes the acquired data by utilizing a physics-based mathematical drilling hydraulic model and data analytics techniques for determining the occurrence of a kick. Once the kick is detected, warnings and alarms are presented to drilling system operators. The embodiments described herein enable the drilling system operators to safely control the kick, thereby improving well control, reducing unnecessary well shut-in events, and reducing costs related to drilling operations.

An exemplary technical effect of the methods, systems, and apparatus described herein includes at least one of: (a) increasing the reliability of automatically detecting kicks during drilling operations; (b) improving the performance of drilling operations by automatically identifying kicks in an early stage; (c) integrating a wide diversity of sensor measurements and techniques to promote data integration and enhance the overall capability of detecting a kick in the early stage; (d) automatically warning of a kick event in the early stage; and (e) incorporating a novel class of sensors, such as the TJL and AFM, for kick detection.

Exemplary embodiments of methods, systems, and apparatus for early well kick detection are not limited to the specific embodiments described herein, but rather, components of systems and/or steps of the methods may be utilized independently and separately from other components and/or steps described herein. For example, the methods may also be used in combination with other drilling systems involving kicks, and are not limited to practice with only the systems and methods as described herein. Rather, the exemplary embodiment can be implemented and utilized in connection with many other applications, equipment, and systems that may benefit from early well kick detection.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An early kick detection system comprising:
at least one sensor associated with a drilling system of a well; and
a kick detection computing device, wherein said kick detection computing device is coupled to said at least one sensor and an operator computing device, said kick detection computing device configured to:
receive measurement data from said at least one sensor, wherein the measurement data includes data measurements associated with one or more kick indicators used to identify a well kick;
generate an estimated value for each of the one or more kick indicators during simulated normal drilling conditions;
generate an estimated value for each of the one or more kick indicators during a simulated kick condition;
determine a deviation value between the estimated values of the one or more kick indicators and the data measurements associated with the one or more kick indicators;
generate a signal based on the deviation value, wherein the signal activates a green status, an amber warning, or a red alarm, wherein the green status, the amber warning, and the red alarm indicate a kick detection status of the drilling system; and
transmit the signal to the operator computing device, wherein the operator computing device is configured to display the kick detection status of the drilling system.

2. The early kick detection system in accordance with claim 1, wherein the one or more kick indicators is at least one of pressure, temperature, and flow rates measured at different positions in the drilling system.

3. The early kick detection system in accordance with claim 1, said kick detection computing device further configured to generate a drilling hydraulic model, wherein the drilling hydraulic model generates the estimated value for each of the one or more kick indicators during simulated normal operating conditions and the estimated value for each of the one or more kick indicators during the simulated kick condition.

4. The early kick detection system in accordance with claim 1, wherein said kick detection computing device is further configured to, based on the deviation, at least one of automatically advise a drilling operator to suspend a predefined operating sequence, initiate drilling to stop, and trigger a well shutdown.

5. The early kick detection system in accordance with claim 1, wherein said at least one sensor includes at least one of an annular flow meter and a tool joint locator.

6. The early kick detection system in accordance with claim 1, wherein the kick detection computing device is further configured to:
determine operational data associated with the drilling system, wherein the operational data includes at least one of plots associated with a kick event, rig operational information, plotting of key drilling variables, trend plots, trend analysis, a blowout preventer joint position, length of a drill string in the well, a pressure profile, a temperature profile, a flow rate profile, equivalent circulating density, and updated well geometry; and
transmit the operational data to the operator computing device, wherein the operator computing device is further configured to display at least one of the plots and analysis results associated with a kick event, the rig operational information, the plotting of key drilling variables, the trend plots, the trend analysis, the blowout preventer joint position, the length of a drill string in the well, the pressure profile, the temperature profile, the flow rate profile, the equivalent circulating density (ECD), and the updated well geometry.

7. The early kick detection system in accordance with claim 1, wherein said kick detection computing device is further configured to use supervised and unsupervised machine learning techniques on the measurement data to determine trends and identify characteristic deviations caused by kicks.

8. A method for controlling an early kick detection system, the early kick detection system including at least one sensor associated with a drilling system of a well and a kick detection computing device coupled to the at least one sensor and an operator computing device, said method comprising:
receiving, by the kick detection computing device, measurement data from the at least one sensor, wherein the measurement data includes data measurements associated with one or more kick indicators used to identify a well kick;
generating, by the kick detection computing device, an estimated value for each of the one or more kick indicators during simulated normal drilling conditions;
generating, by the kick detection computing device, an estimated value for each of the one or more kick indicators during a simulated kick condition;
determining, by the kick detection computing device, a deviation value between the estimated values of the one or more kick indicators and the data measurements associated with the one or more kick indicators;
generating, by the kick detection computing device, a signal based on the deviation value, wherein the signal activates a green status, an amber warning, or a red alarm, wherein the green status, the amber warning, and the red alarm indicate a kick detection status of the drilling system; and
transmitting, by the kick detection computing device, the signal to the operator computing device, wherein the operator computing device is configured to display the kick detection status of the drilling system.

9. The method in accordance with claim 8, wherein the one or more kick indicators is at least one of pressure, temperature, and flow rates measured at different positions in the drilling system.

10. The method in accordance with claim 8 further comprising generating, by the kick detection computing device, a drilling hydraulic model, wherein the drilling hydraulic model generates the estimated value for each of the one or more kick indicators during simulated normal operating conditions and the estimated value for each of the one or more kick indicators during a simulated kick condition.

11. The method in accordance with claim 8 further comprising performing, by the kick detection computing device, at least one of automatically advising a drilling operator to suspend a predefined operating sequence, initiating drilling to stop, and triggering a well shutdown, based on the deviation.

12. The method in accordance with claim 8, wherein the data measurements are received from at least one of an annular flow meter and a tool joint locator.

13. The method in accordance with claim 8 further comprising:
determining, by the kick detection computing device, operational data associated with the drilling system, wherein the operational data includes at least one of plots associated with a kick event, rig operational information, plotting of key drilling variables, trend plots, trend analysis, a blowout preventer joint position, length of a drill string in the well, a pressure profile, a temperature profile, a flow rate profile, equivalent circulating density, and updated well geometry; and
transmitting, by the kick detection computing device, the operational data to the operator computing device, wherein the operator computing device is further configured to display at least one of the plots and analysis results associated with a kick event, the rig operational information, the plotting of key drilling variables, the trend plots, the trend analysis, the blowout preventer joint position, the length of a drill string in the well, the pressure profile, the temperature profile, the flow rate profile, the equivalent circulating density (ECD), and the updated well geometry.

14. The method in accordance with claim 8 further comprising using, by the kick detection computing device, supervised and unsupervised machine learning techniques on the measurement data to determine trends and identify characteristic deviations caused by kicks.

15. A non-transitory computer-readable storage medium having computer-executable instructions embodied thereon, wherein when executed by a kick detection computing device coupled to at least one sensor associated with a drilling system of a well and an operator computing device, the computer-executable instructions cause the kick detection computing device to:
receive measurement data from the at least one sensor, wherein the measurement data includes data measurements associated with one or more kick indicators used to identify a well kick;
generate an estimated value for each of the one or more kick indicators during simulated normal drilling conditions;
generate an estimated value for each of the one or more kick indicators during a simulated kick condition;
determine a deviation value between the estimated values of the one or more kick indicators and the data measurements associated with the one or more kick indicators;
generate a signal based on the deviation value, wherein the signal activates a green status, an amber warning, or a red alarm, wherein the green status, the amber warning, and the red alarm indicate a kick detection status of the drilling system; and
transmit the signal to the operator computing device, wherein the operator computing device is configured to display the kick detection status of the drilling system.

16. The non-transitory computer-readable storage medium of claim 15, wherein the one or more kick indicators is at least one of pressure, temperature, and flow rates measured at different positions in the drilling system.

17. The non-transitory computer-readable storage medium of claim 15, wherein the computer-executable instructions further cause the kick detection computing device to generate a drilling hydraulic model, wherein the drilling hydraulic model generates the estimated value for each of the one or more kick indicators during simulated normal operating conditions and the estimated value for each of the one or more kick indicators during the simulated kick condition.

18. The non-transitory computer-readable storage medium of claim 15, wherein the computer-executable instructions further cause the kick detection computing device to at least one of automatically advise a drilling operator to suspend a predefined operating sequence, initiate drilling to stop, and trigger a well shutdown, based on the deviation.

19. The non-transitory computer-readable storage medium of claim 15, wherein the data measurements are received from at least one of an annular flow meter and a tool joint locator.

20. The non-transitory computer-readable storage medium of claim 15, wherein the computer-executable instructions further cause the kick detection computing device to:
determine operational data associated with the drilling system, wherein the operational data includes at least one of plots associated with a kick event, rig operational information, plotting of key drilling variables, trend plots, trend analysis, a blowout preventer joint position, length of a drill string in the well, a pressure profile, a temperature profile, a flow rate profile, equivalent circulating density, and updated well geometry; and
transmit the operational data to the operator computing device, wherein the operator computing device is further configured to display at least one of the plots and analysis results associated with a kick event, the rig operational information, the plotting of key drilling variables, the trend plots, the trend analysis, the blowout preventer joint position, the length of a drill string in the well, the pressure profile, the temperature profile, the flow rate profile, the equivalent circulating density (ECD), and the updated well geometry.

21. The non-transitory computer-readable storage medium of claim 15, wherein the computer-executable instructions further cause the kick detection computing device to use supervised and unsupervised machine learning techniques on the measurement data to determine trends and identify characteristic deviations caused by kicks.
